(19) United States
(12) Patent Application Publication
(10) Pub. No.: US 2002/0192435 A1
(43) Pub. Date: Dec. 19, 2002

(54) Towel with segregated body part areas

(76) Inventor: William D. Poe III, Charleston, SC (US)

Correspondence Address: COATS & BENNETT, PLLC, P O BOX 5, RALEIGH, NC, 27602, US

(21) Appl. No.: 09/881,345

(22) Filed: Jun. 14, 2001

(51) Int. Cl. B32B 3/00; B32B 27/14

(52) U.S. Cl. 428/195

(57) ABSTRACT

A towel that is divided into a plurality of areas with each area being designated to be used on a particular body area. For example, in one embodiment, the towel is divided into four discrete areas that are marked “head”, “body”, “feet”, and “buttocks”.

### FIELD OF THE INVENTION

The present invention relates to body towels.

### SUMMARY OF THE INVENTION

The present invention entails a towel that is divided into a series of separate and distinct areas. Each separate area of the towel is intended to be used on a certain portion of the body. Thus, for example, one of the divided areas would be used on a person's head while another separate area would be used on the person's feet. In one specific embodiment of the present invention, the towel is divided into four separate and distinct areas. One area is designated for the head, another area is designated for the feet, yet another area is designated for the buttocks, and the remaining fourth area is designated for the general body and is used on the remaining areas of the body such as the chest, back, arms, hands, legs, etc.

### BRIEF DESCRIPTION OF THE DRAWINGS

FIG. 1 is a plan view of a towel of the present invention.

### DETAILED DESCRIPTION OF THE INVENTION

The present invention entails a towel that is indicated in the drawings generally by the numeral 10. Towel 10 is basically a body towel, that is a towel that is used to wipe and dry the body after bathing or showering. Various types of fabrics and constructions can be utilized in the towel 10. For example, it is common practice that towels assume, for example, a terry knit construction. In any event, the type of fabric and the construction utilized to manufacture the towel 10 of the present invention is not in itself, per se, material to the present invention as the towel 10 of the present invention can be manufactured according to any number of conventional towel manufacturing techniques.

Towel 10 includes an outer terminal edge 12. In the embodiment illustrated herein, the towel 10 assumes a generally rectangular configuration. However, it is appreciated that the shape and size of the towel 10 may vary.

Towel 10 is divided into a series of body areas. These body areas are distinct and are separated from each other and are referred to in the drawings by numerals 14, 16, 18 and 20. In the case of the embodiment illustrated herein, the rectangular configured towel 10 is divided into four generally equal areas. However, again it should be emphasized that the manner in which the towel is divided can vary and even the size or area of the individual body areas could vary also.

Towel 10 is also provided with indicia that identify each particular body area and which correlates the segregated area of the towel with a particular portion of the body. For example, in the embodiment illustrated herein, body area 14 includes indicia indicating that this area of the towel is to be used on the “head”. Inscribed or otherwise incorporated into body area 18 is indicia indicating that this part of the towel is to be used on the “feet”. Body area 20 includes indicia indicating that this portion of the towel 10 is to be used on the buttocks. Finally, the body area designated by the numeral 16 includes indicia associated therewith that refers to this body area as being intended for use on the “body”. Essentially, this means that body areas 16 is designated for use on all other areas of the body except the head, feet, and buttocks.

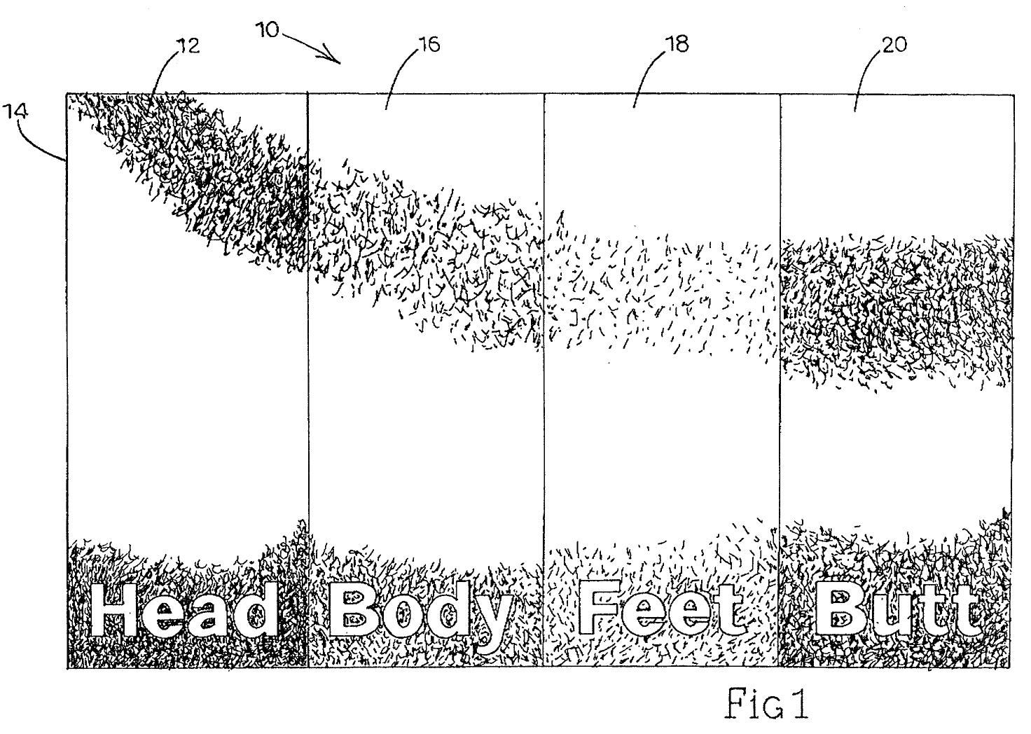

It is appreciated that the number of body areas incorporated into the towel 10 can vary and that these body areas may include other body part designations than those found in the towel shown in FIG. 1. For example, the designated body areas might refer to other parts of the body such as arms, hands, chest, back, hips, legs, etc.

The indicia utilized on the towel 10 to identify the body area may take other forms. For example, symbols or other graphic illustrations may be incorporated into the towel to identify the body areas of the towel and particularly to correlate the respective body areas with certain portions of the body. In the way of examples, an illustration or symbol of a person's head could be incorporated into a body area of a towel to indicate that that area of the towel is intended to be used on the head. Likewise, symbols or graphic illustrations of the feet or buttocks could also be incorporated into respective body areas of the towel.

Finally, in the case of the towel 10 of the present invention, the respective body areas 14, 16, 18, and 20 are separated and designated by different colors. For example, as indicated in the drawings, body area 14 is shown to be in the color red while body area 16 is shown to assume the color blue. Further, body area 18 is shown to assume the color white while the final body area 20 is shown in the color black.

From the foregoing specification and discussion, it is appreciated that the towel 10 of the present invention includes a series of distinct and separate body areas defined throughout the towel 10. These body areas can be provided on one side or even both sides of the towel. It follows that a person using the towel 10 would use certain portions or body areas of the towel on certain parts of the body. By discretely using the towel 10 as described above, individuals may feel more comfortable in utilizing the same towel on several different occasions without the towel being laundered.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A towel comprising: a series of segregated body areas formed on the towel; and indicia associated with respective segregated body areas for identifying a particular area of the human body.

2. The towel of claim 1 including an outer terminal edge and wherein one or more of the segregated body areas are defined in part at least by the outer terminal edge of the towel.

3. The towel of claim 1 wherein the indicia is provided within the segregated body areas of the towel.

4. The towel of claim 3 wherein the indicia is taken from the group including head, body, feet, butt, and buttocks

5. A towel having discreet areas designated for certain parts of the human body comprising:
a sheet of pliable cloth material having an outer terminal edge and a series of defined and segregated areas formed on the towel with a plurality of the segregated areas designated to be used on a certain portion of the human anatomy.

6. The towel of claim 5 including indicia associated with a plurality of the segregated areas and wherein the indicia designates a particular portion of the human body that is to be engaged with respective segregated areas of the towel.

7. A towel comprising a pliable cloth material having an outer terminal edge; the towel being divided into a plurality of distinct areas where each distinct area is designed to be used on a particular portion of the human body; and indicia associated with each distinct area for identifying the portion of the human body that that distinct area is to be used on.

8. The towel of claim 7 wherein the towel is multicolored and wherein each distinct area includes a distinguishing color.

9. The towel of claim 7 wherein each distinct body area includes a marking that distinguishes it from one or more adjacent distinct body areas.

10. The towel of claim 7 wherein the distinct body areas are designed to be used on certain body portions taken from the group including head, body, feet, buttocks, arms, hands, chest, back, hips and legs.

11. The towel of claim 7 where the indicia utilized on the towel is taken from the group including head, body, feet, buttocks, arms, hands, chest, back, hips and legs.
